(19) United States
(12) Patent Application Publication
(10) Pub. No.: US 2016/0209989 A1
(43) Pub. Date: Jul. 21, 2016

(54) RECORD AND REPLAY OF OPERATIONS ON GRAPHICAL OBJECTS

(71) Applicants: Jin-Feng LUAN, Pudong, Shanghai (CN); Yi-Qun REN, Pudong, Shanghai (CN); Dror SAARONI, Yehud (IL); HEWLETT-PACKARD DEVELOPMENT COMPANY, L.P., Houston, TX (US)

(72) Inventors: Yi-Qun Ren, Shanghai (CN); Dror Searoni, Yehud (IL); Jin-Feng Luan, Shanghai (CN)

(21) Appl. No.: 14/915,308

(22) PCT Filed: Sep. 30, 2013
(86) PCT No.: PCT/CN2013/084802

§ 371 Date: Feb. 29, 2016

(51) Int. Cl. G06F 3/0481

(52) U.S. Cl. CPC G06F 3/0481

(57) ABSTRACT

Disclosed herein are a system, non-transitory computer readable medium, and method for recording and replaying user operations. An appearance of a graphical object is recorded. It is determined whether the recorded appearance is different than the current appearance of the graphical object.

### BACKGROUND

Test automation software may record and automatically replay user interactions with a graphical user interface (“GUI”). GUI developers may use automation software to record and replay mouse input (e.g., points and clicks) and web developers may use it to record and replay web page navigations. These tools alleviate manual testing, which is often laborious and time-consuming.

### BRIEF DESCRIPTION OF THE DRAWINGS

FIG. 1 is an example system in accordance with aspects of the disclosure.

FIG. 2 is an example flow diagram in accordance with aspects of the disclosure.

FIG. 3 is a working example in accordance with aspects of the disclosure.

FIG. 4 is a further working example in accordance with aspects of the disclosure.

### DETAILED DESCRIPTION

As noted above, GUI developers may use test automation to record user operations and to replay those operations automatically as many times as needed. Such tools save a significant amount of time in quality assurance and regression testing. Some test automation tools use an agent-based approach. In this approach, an agent module may be inserted into an application under test (“AUT”). The agent may record information associated with graphical objects as users interact therewith and may also replay those user interactions when needed. One advantage of an agent-based approach is the precision with which graphical data can be captured during the recording phase. An agent may capture detailed data associated with complex graphical user interfaces, such as graphical tree views and calendars. However, the agent-based approach has some disadvantages. For example, if the AUT is executing remotely, security restrictions may prevent insertion of the agent into the remote computer. Furthermore, customized agents may have to be developed for each platform. For example, specific agents may need to be developed for each version of Internet Explorer®.

In view of the foregoing, various examples disclosed herein provide a system, non-transitory computer-readable medium, and method for recording and replaying user operations. In one aspect, an appearance of a graphical object may be recorded. In a further aspect, it may be determined whether the recorded appearance is different than the current appearance of the graphical object. In another example, particular images, text, and pixel measurements of the graphical object may be recorded. Thus, the system, non-transitory computer-readable medium, and method disclosed herein may capture details of complex graphical objects based on the user interface displayed on the screen without having to insert an agent into the AUT. The techniques disclosed herein capture precise details of the displayed graphical objects commensurate with the details gathered using an agent based approach. The aspects, features and advantages of the application will be appreciated when considered with reference to the following description of examples and accompanying figures. The following description does not limit the application; rather, the scope of the application is defined by the appended claims and equivalents.

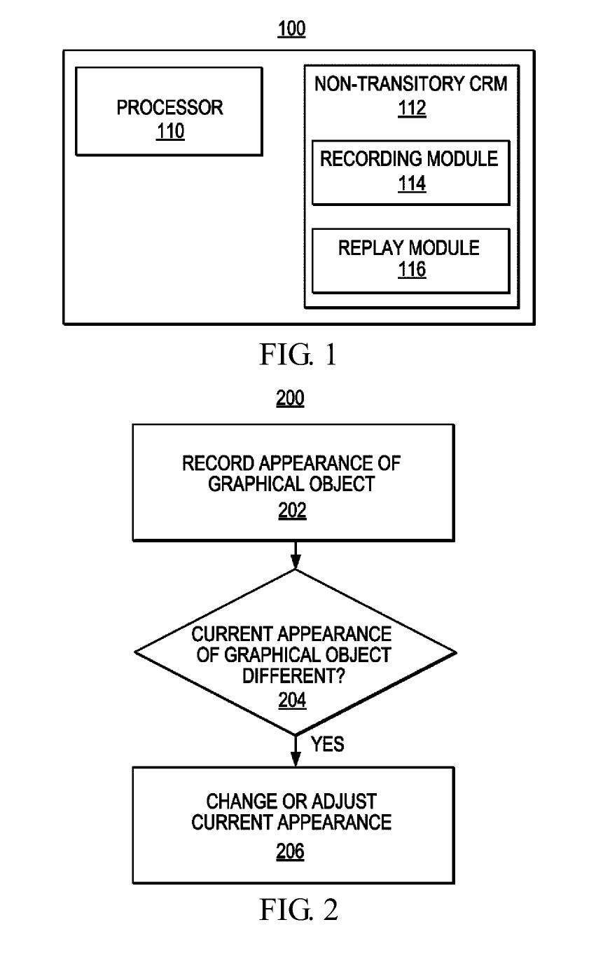

FIG. 1 presents a schematic diagram of an example system that includes an illustrative computer apparatus 100. FIG. 1 depicts various components in accordance with aspects of the disclosure. The computer apparatus 100 may include all the components normally used in connection with a computer. For example, it may have a keyboard, mouse, and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network using conventional protocols (e.g., Ethernet, Wi-Fi, Bluetooth, etc.). The computer apparatus 100 may also contain a processor 110, which may be any number of well known processors, such as processors from Intel® Corporation. In another example, processor 110 may be an application specific integrated circuit (“ASIC”).

Non-transitory computer readable medium (“CRM”) 112 may store instructions that may be retrieved and executed by processor 110. As will be discussed in more detail below, the instructions may include recording module 114 and a replay module 116. Non-transitory CRM 112 may be used by or in connection with any instruction execution system that can fetch or obtain the logic from non-transitory CRM 112 and execute the instructions contained therein.

Non-transitory CRM 112 may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 (e.g., recording module 114 and replay module 116) may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, recording module 114 may instruct processor 110 to record at least one user operation that changes an appearance of a graphical object to a target appearance and to record the target appearance. In another example, replay module 116 may instruct processor 110 to determine whether a current appearance of the graphical object is different from the recorded target appearance and to change the current appearance to the target appearance so as to repeat the at least one user operation.

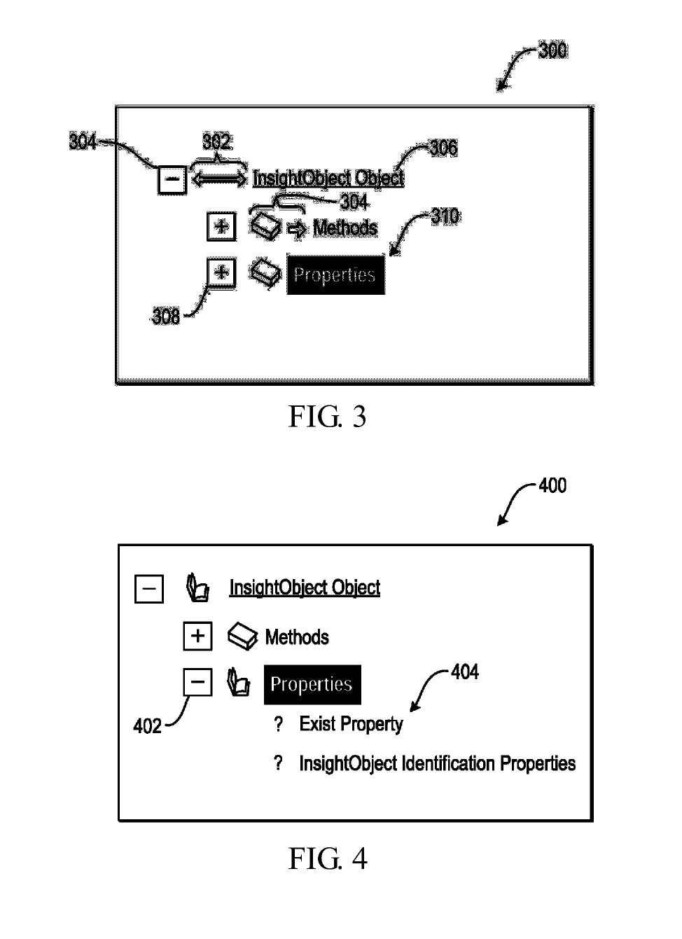

Working examples of the system, method, and non-transitory computer-readable medium are shown in FIGS. 2-4. In particular, FIG. 2 illustrates a flow diagram of a process for recording and replaying user operations. FIGS. 3-4 show example screen shots in accordance with aspects of the techniques disclosed herein. The actions shown in FIGS. 3-4 will be discussed below with regard to the flow diagram of FIG. 2.

As shown in block 202 of FIG. 2, an appearance of a graphical object may be recorded. The recorded appearance may include features of the appearance such as particular images, text, and pixel measurements. The appearance may be the target appearance. In one example, the target appearance may be defined as the final appearance sought after by the user operations. In another example, an initial appearance of the graphical object may also be recorded. In one example, the initial appearance may be defined as the appearance of the graphical object before at least one user operation changed the appearance of the graphical object.

Referring now to FIG. 3, an example tree view 300 is shown. FIG. 3 shows an initial appearance of tree view 300 before user interactions with the tree view begin. Recording module 114 may record features of the initial appearance. As noted above, the features may include particular images, text, and pixel measurements. For example, in FIG. 3, recording module 114 may record pixel measurement 302 between image 304 and text 306. Furthermore, recording module 114 may record image 308, and image 304. Referring now to FIG. 4, a target appearance is shown after execution of at least one user operation. Here, image 308 has changed to image 402 and image 310 has been expanded to expanded tree view 404. The particular images, text, and pixel measurements of this target appearance may also be recorded.

The images, pixel measurements, and text may be recorded in a variety of ways. For example, coordinates (e.g., x and y coordinates or height and width) may be recorded via an application programming interface. For example, the pixel measurement 302 between image 304 and text 306 may be recorded by determining the x coordinates therebetween. By way of further example, the y coordinates of the expanded tree view 404 may be recorded. In another example, optical character recognition (“OCR”) may be used to record text, such as text 306 in FIG. 3 or the text in expanded tree view 404. In yet a further example, images, such as image 308 and image 402, may be parsed and recorded. The parsing may comprise parsing the pixels within the images.

Referring back to FIG. 2, it is determined whether the current appearance of the graphical object is different than the target appearance, as shown in block 204. In one example, replay module 116 may determine the current appearance of the graphical object by comparing particular images, text, and pixel measurements of the current appearance to those of the recorded initial appearance. In another example, the replay module 116 may detect features of the current appearance and compare the detected features to the recorded features of the target appearance. Referring back to FIG. 2, if the current appearance is different than the target appearance, the current appearance may be adjusted or changed to look like the target appearance so as to repeat or replay the at least one user operation, as shown in block 206. Replay module 116 may transmit commands to the AUT to change the graphical object to the target appearance.

Advantageously, the above-described system, non-transitory computer readable medium, and method record details of a graphical object as a user interacts therewith and replays the user interactions by adjusting the image as did the user interactions. In this regard, fine details of the image may be recorded so that complex graphical objects may be adjusted in accordance with the recorded user operations. In turn, testing engineers can be rest assured that a high quality automated test can be carried out, even if an agent based approach is not possible.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the application as defined by the appended claims. Furthermore, while particular processes are shown in a specific order in the appended drawings, such processes are not limited to any particular order unless such order is expressly set forth herein. Rather, processes may be performed in a different order or concurrently.

1. A system comprising:
a recording module which upon execution instructs at least one processor to record at least one user operation that changes an appearance of a graphical object to a target appearance and to record the target appearance; and
a replay module which upon execution instructs at least one processor to determine whether a current appearance of the graphical object is different from the recorded target appearance and to change the current appearance to the target appearance so as to repeat the at least one user operation.

2. The system of claim 1, wherein to record the target appearance the recording module upon execution instructs at least one processor to record features of the target appearance.

3. The system of claim 2, wherein to determine whether the current appearance is different from the target appearance the replay module upon execution instructs at least one processor to:
detect features of the current appearance of the graphical object; and
compare the detected features of the current appearance to the recorded features of the target appearance.

4. The system of claim 2, wherein the features of the target appearance comprise particular images, text, and pixel measurements of the target appearance.

5. The system of claim 1, wherein the replay module upon execution further instructs at least one processor compare particular images, text, and pixel measurements of the current appearance to those of an initial appearance of the graphical object before the at least one operation changed the graphical object.

6. A non-transitory computer readable medium having instructions therein which, if executed, cause at least one processor to:
read data associated with a recorded appearance of a graphical object;
detect data associated with a current appearance of the graphical object;
determine whether the graphical object appears differently from the recorded appearance based at least partially on a comparison between data associated with the current appearance and data associated with the recorded appearance; and
adjust the current appearance of the graphical object to the recorded appearance, if the graphical object appears differently.

7. The non-transitory computer readable medium of claim 6, wherein the data associated with the recorded appearance of the graphical object comprises features of the recorded appearance.

8. The non-transitory computer readable medium of claim 7, wherein the data associated with the current appearance of the graphical object comprises features of the current appearance.

9. The non-transitory computer readable medium of claim 8, wherein to determine whether the graphical object appears differently the instructions therein upon execution further instruct at least one processor to compare the features of the recorded appearance to the features of the current appearance.

10. The non-transitory computer readable medium of claim 7, wherein the features of the recorded appearance and the current appearance comprise particular images, text, and pixel measurements within the graphical object.

11. A method comprising recording, using at least one processor, data associated with a target appearance of a graphical object caused by at least one user operation performed on the graphical object;
replaying, using at least one processor, the at least one user operation performed on the graphical object;
determining, using at least one processor, whether a current appearance of the graphical object is different from the target appearance; and
changing, using at least one processor, the current appearance to the target appearance, if the current appearance is different from the target appearance so as to replay the at least one user operation successfully.

12. The method of claim 11, wherein recording the data associated with the target appearance comprises recording, using at least one processor, features of the target appearance.

13. The method of claim 12, wherein determining whether the current appearance of the graphical object is different from the target appearance comprises:
detecting, using at least one processor, features of the current appearance of the graphical object; and
comparing, using at least one processor, features of the current appearance to features of the target appearance.

14. The method of claim 11, wherein features of the target appearance comprise particular images, text, and pixel measurements.

15. The method of claim 11, further comprising:
recording, using at least one processor, data associated with an initial appearance of the graphical object before the at least one operation was performed; and
comparing, using at least one processor, particular images, text, and pixel measurements of the current appearance to that of the initial appearance.
